(19) United States
(12) Patent Application Publication
(10) Pub. No.: US 2007/0220218 A1
(43) Pub. Date: Sep. 20, 2007

(54) Apparatus and method for memory control, and mobile device

(75) Inventor: Takumi Kato, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/714,749

(22) Filed: Mar. 7, 2007

(30) Foreign Application Priority Data
Mar. 17, 2006 (JP) 2006-075369

(51) Int. Cl. G06F 13/00

(52) U.S. Cl. 711/154

(57) ABSTRACT

A memory control apparatus that includes a queue to store up to 2 access requests to a memory and a command issuer to issue a command to the memory according to access requests stored to the queue. The command issuer includes an address comparator to evaluate whether the access requests stored to the queue are for a same page of the memory. If the access requests are for a same page, the command issuer consecutively issues read/write commands, whereas if the access requests are for different pages, the command issuer issues a pre-charge command after issuing one read command.

### BACKGROUND OF THE INVENTION

1. Field of the Invention

The present invention relates to an apparatus and a method for memory control, and a mobile device having a memory control apparatus mounted thereto.

2. Description of Related Art

FIG. 10 is a view showing a conventional memory controller. A DMA (Direct Memory Access) 101 and a CPU (Central Processing Unit) 102 that are connected to a bus 103 access to a memory 104 via a memory controller 110. The memory controller 110 includes a command issuer 111 that issues a command to the memory 104 in response to an access request from the DMA 101 and the CPU 102.

When an access request is issued to the memory controller 110 from the DAM 101 and CPU 102 or the like, the command issuer 111 of the memory controller 110 generates a command for reading or writing data and issues the command to the memory 104.

FIG. 11 is a block diagram showing a SDRAM (Synchronous Dynamic Random Access Memory) of 128 Mbits (2M words×16 bits×4 banks) as an example of the memory 104 (For example see ELPIDA, How to Use SDRAM-User's Manual, Document No. J0123N60 (Ver.6.0), Japan, February 2005, P 20-22, Searched on Feb. 2, 2005, <http://www.elpida.com/pdfs/J0234E40.pdf>). A SDRAM 200 includes four banks 201₀ to 201₃, an address buffer 202, a refresh counter 203, and an I/O buffer 204. Each of the banks 201₀ to 201₃ are configured in the same way. For example the bank 201₀ is constituted of a memory cell array 211₀, an address decoder (row decoder 212₀ and a column decoder 213₀), and a sense amplifier 214₀. In the explanation below, if not required to distinguish the abovementioned components, they are referred to as a bank 201, a memory cell array 211, a row decoder 212, a column decoder 213, and a sense amplifier 214.

The SDRAM 200 is a memory in which an access time of read/write is fixed by synchronizing all external interfaces with clocks so as to accomplish high speed operations. One of the characteristics of SRAMs is that a memory cell is divided into independently operational blocks (banks). This is called a multi-bank operation. The larger the number of the banks, the better the drive capability of each cell array to enable high speed accesses. However in light of the number of sense amplifiers, a drive capability, and a degree of integration, the standard configuration is constituted of 4 banks.

The bank 201 is a memory cell group divided into 4 memory cell arrays, for example, to enable a parallel operation. The memory cell of the memory cell array 211 is constituted of one transistor and one capacitor. The row decoder 212 takes a bank select signal for selecting a bank and a row address at an ACT, which is described later in detail, to select a row (word line) The column decoder 213 takes a bank select signal and a column address at a READ/WRITE operation to select a corresponding column (bit line and digit line). The refresh counter 203 is a counter for automatically counting row addresses inside memory. The I/O buffer 204 is a buffer for inputting and outputting data. A page is composed of a particular bank and a particular row. A particular column and a particular row are selected by an address A0 to A11 for example that are input to the address buffer 202, and a bank is selected by a bank address BA0 to BA1. When a page is selected by a particular bank and a particular row, the selected page is activated, and desired data can be read or written by specifying a column address in the activated page.

An operation of the SDRAM is described hereinafter in detail. The SDRAM's state transits as in FIG. 12 (for example see XILINX, DDR SDRAM Controller Using Virtex-4 FPGA Devices, XAPP709(v1.3), Aug. 27, 2005, P 11, Searched on Feb. 2, 2005, <http://www.xilinx.com/bvdocs/appnotes/xapp709.pdf>). An IDLE state is a state to be a starting point of all operations, where a bank to be selected must be in the IDLE state when inputting various commands. An ACTIVE state is a state in which a row address is selected and any operation request including a read and write commands are not issued. By inputting an active command (ACT) to the selected row address, the SDRAM becomes the ACTIVE state. A PRE-CHARGE state is a state after finishing an operation for a current row address to starting another operation for a different row address. Devices automatically return to the PRE-CHARGE state by inputting a pre-charge command (PRE). A READ/WRITE state is a state in which a read or a write operation is being executed. Devices transit to the READ/WRITE state from the ACTIVE (row active) state by inputting a read or write command to the selected column address.

By the way, each input and output signal is synchronized with CLK. The time required from specifying a row address to specifying a column address is referred to as a RAS-CAS latency. The time required from specifying a column address to determining data is referred to as a CAS latency (CL).

As described in the foregoing, the SDRAM requires some time for read and write operations because of the latency included therein. Accordingly there are two kinds of the conventional SDRAM 200; one that transits its state focusing on the speed with as least latency as possible, and another that transits its state aiming to operate with low power consumption (for example see ELPIDA, DRR How to Use SDRAM-User's Manual, Document No. J0234E30 (Ver.3.0), Japan, April 2002, P 50, 62, and 72, Searched on Feb. 2, 2005 <http://www.elpida.com/pdfs/J0123N60.pdf>).

Specifically, for the SDRAM focusing on the speed, when the memory controller 110 receives an access request to the memory, a corresponding page of the memory 104 is activated and the SDRAM maintains to be in the ACTIVE state (READ WAIT/WRITE WAIT) by issuing a READ/WRITE command so as to suppress the latency in access time (see FIG. 12). By maintaining the ACTIVE state, it is possible to save the time to transit from the IDLE to ACTIVE state. Therefore, if there is a request for read/write operation while maintaining the ACTIVE state, a read/write operation can be immediately executed. Then after waiting for a predetermined time to pass, a pre-charge is performed to return to the IDLE state.

On the other hand for the SDRAM focusing on the power consumption, after executing a read/write operation by a read/write command READA/WRITEA with auto pre-charge for automatically pre-charging, a pre-charge is immediately started to return to the IDLE state. Specifically, the necessary power consumption can be saved by maintaining the ACTIVE state.

In the explanation below, a read operation is described as an example however it is same for a write operation. FIG. 13 is a timing chart when a consecutive read is performed after a read operation without pre-charging. Further, FIG. 14 is a timing chart when a read command READA with auto pre-charge is executed.

As shown in FIG. 13, by performing a consecutive READ without auto pre-charging, first READ data (Qa0 to Qa3) and second READ data (Qb0 to Qb3) are consecutively output. This enables to shorten for cycles to activate (6 cycles in this example) as compared to when pre-charging after the first read operation.

Further as shown in FIG. 14, when the read command READA with auto pre-charge is executed, it is automatically pre-charged at a timing T5 after the read operation, returns to the IDLE state at a timing T8, and does not maintain to be in the ACTIVE state. Thus the power consumption can be reduced. Note that at the timing T8, an ACT can be input and it is possible to transit again to the ACTIVE state thereby. When performing a consecutive read by the read command with auto pre-charge READA, a next READA command is issued after the ACT at the timing T8, the timing will be a timing T13 not shown in which second data is output.

However in the abovementioned SDRAM operation, it has now been discovered that if the speed is focused, the power consumption increases because the latency in the ACTIVE state is long. Specifically, if the SDRAM is mounted to a mobile device etc., the power consumption needs to be as low as possible. However in the ACTIVE state, the power consumption of the memory increases ten times more than in the IDLE state. On the other hand if the low power consumption is focused, there is another problem that the latency of the memory access increases because of the need to transit to the ACTIVE state every time.

### SUMMARY OF THE INVENTION

According to an aspect of the present invention, there is provided a memory control apparatus that includes a queue to store 2 or more access requests to a memory and a command issuer to include an evaluator to evaluate whether the 2 or more access requests stored to the queue are access requests for a same page of the memory. The command issuer issues a command to the memory according to the evaluation result by the evaluator.

In the present invention, the command issuer evaluates whether the access requests to the memory is for the same page. Thus it is possible to determine whether to make it a low power consumption or a high speed operation so as to issue a command for a memory access.

According to another aspect of the present invention, there is provided a mobile device that includes a memory, a memory controller to control the memory, a controller to access the memory via the memory control apparatus. The memory controller includes a queue to store 2 or more access requests to the memory and a command issuer to include an evaluator to evaluate whether the 2 or more access requests stored to the queue are access requests for a same page of the memory. The command issuer issues a command to the memory according to the evaluation result by the evaluator.

In the present invention, a memory controller is included that evaluates whether to make it a low power consumption or a high speed operation so as to issue a command for a memory access. This improves an operational characteristic while maintaining a low power consumption, that is important to mobile devices.

Accordingly, the present invention provides an apparatus and a method for memory control that maintains the power consumption of the memory as low as possible while reducing the latency in memory accesses, and a mobile device having such a memory control apparatus mounted thereto.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing a memory controller and peripheral circuitry thereof according to an embodiment of the present invention;

FIG. 2 is a schematic diagram showing a cellular phone as an example of an apparatus having the memory controller according to an embodiment of the present invention;

FIG. 3 is a state transition diagram of a memory that is controlled by the memory controller according to an embodiment of the present invention;

FIG. 4 is a timing chart showing an operation when the memory controller according to an embodiment of the present invention compares addresses at a timing T3;

FIG. 5 is a timing chart explaining a read command READ and a read command with auto pre-charge READA;

FIG. 6 is a timing chart explaining a difference in operations of READ and READA if consecutive access requests are for different banks;

FIG. 7 is a flowchart showing an operation when the memory controller according to an embodiment of the present invention compares addresses at the timing T3;

FIG. 8 is a flowchart showing an operation when the memory controller according to an embodiment of the present invention compares addresses at a timing T5;

FIG. 9.is a timing chart showing an operation when the memory controller according to an embodiment of the present invention compares addresses at the timing T5;

FIG. 10 is a view showing a conventional memory controller;

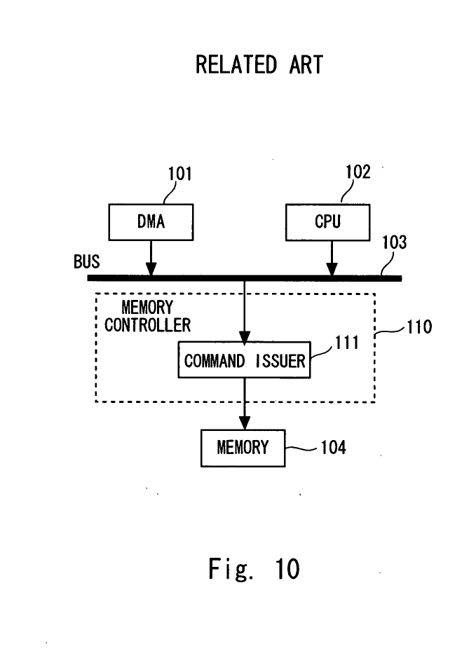

FIG. 11 is a block diagram showing a SDRAM of 128 Mbits (2M words×16 bits×4 banks) as an example of a conventional memory;

FIG. 12 is a view showing a state transition of a conventional memory;

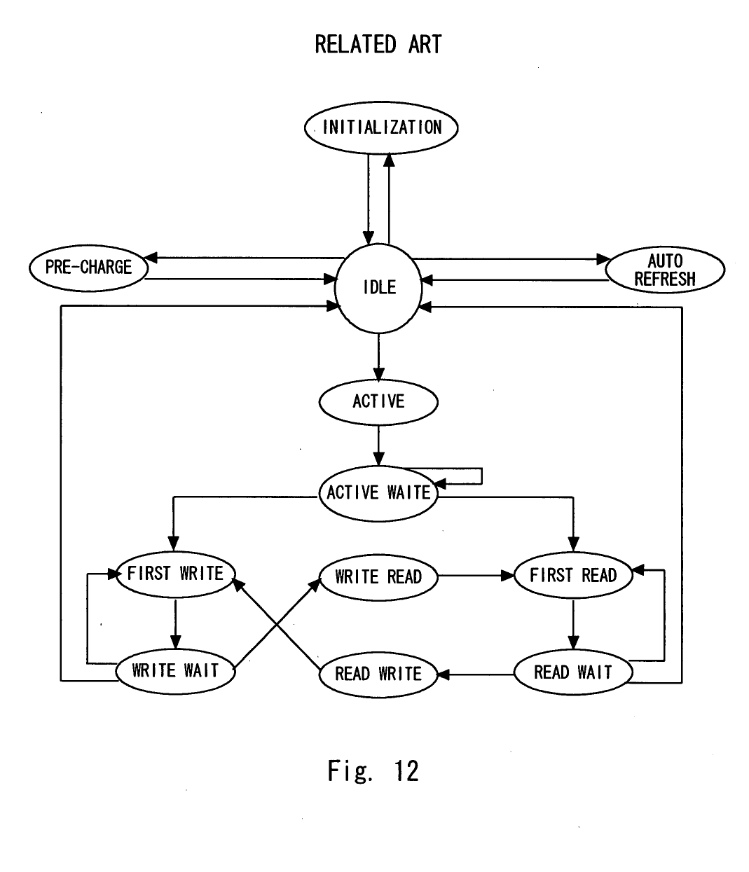

FIG. 13 is a timing chart for explaining a conventional memory control operation focusing on speed, when performing a consecutive read without pre-charging after a read operation; and

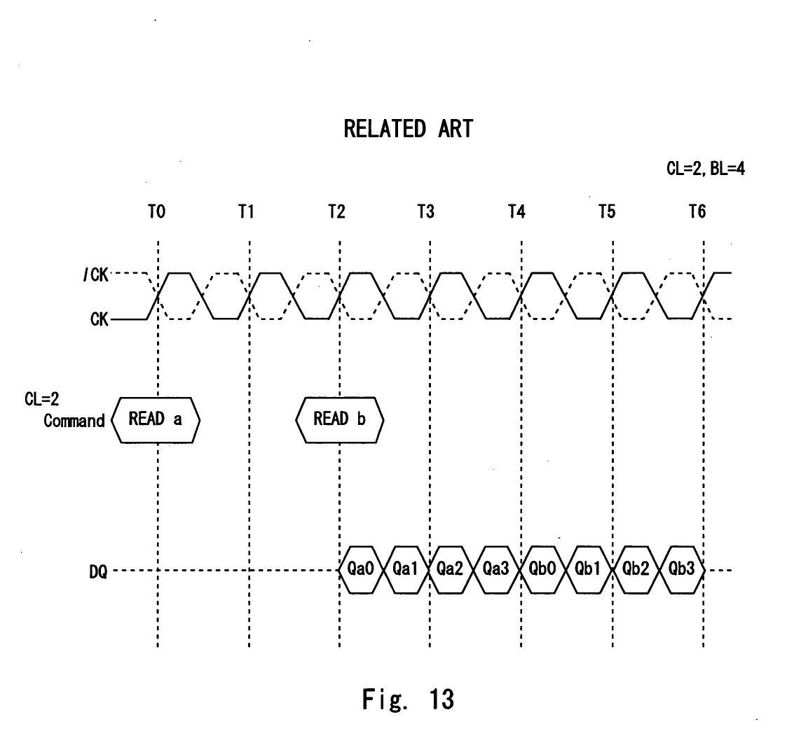

FIG. 14 is a timing chart for explaining a conventional memory control operation focusing on speed, when performing a READA command with auto pre-charge.

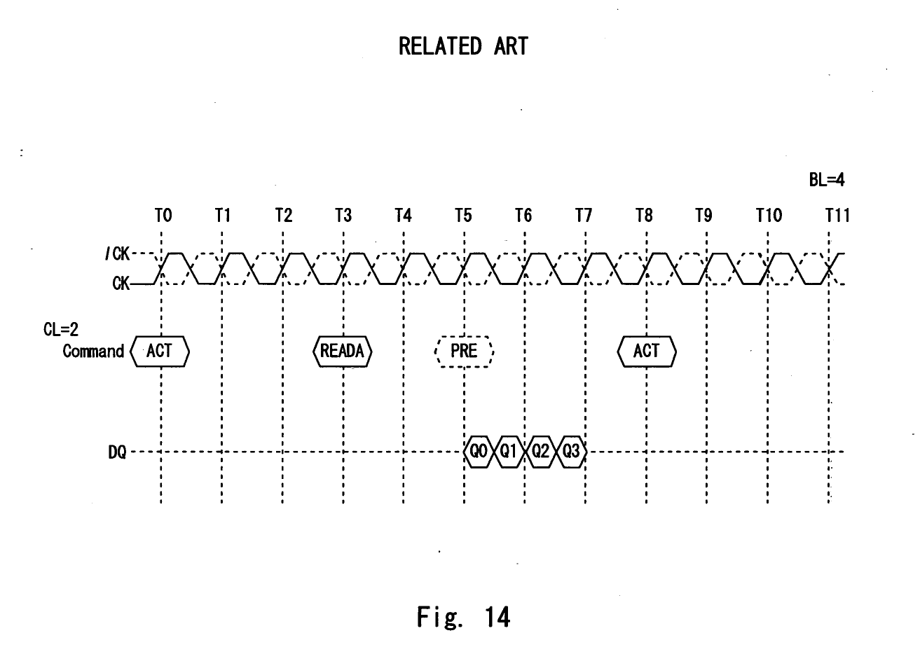

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

In this embodiment, the present invention is applied to a memory controller of a SDRAM maintaining a low power consumption with as small latency as possible.

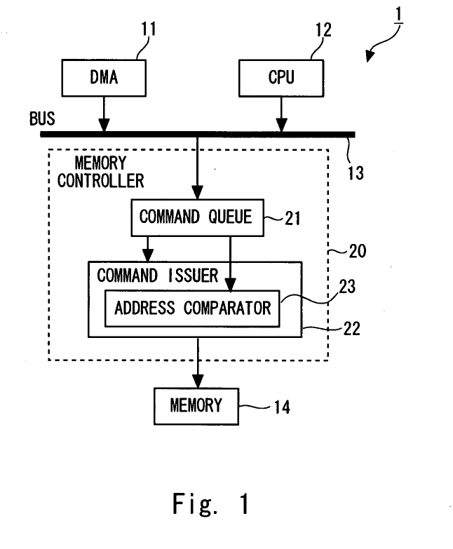

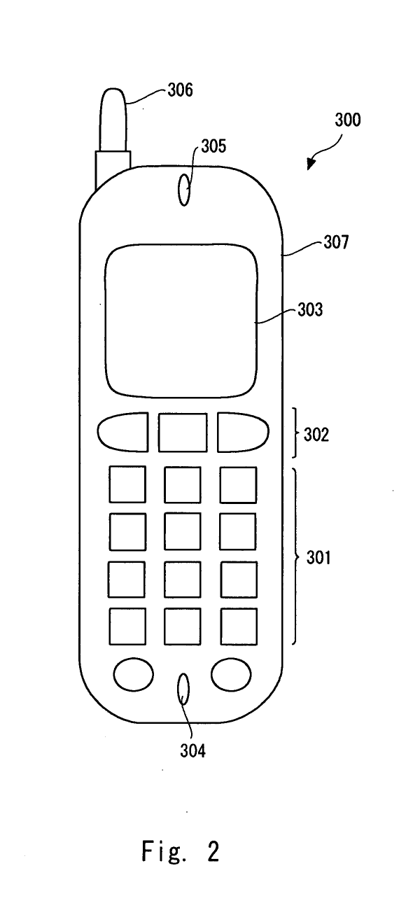

FIG. 1 is a block diagram showing a memory controller and a peripheral circuitry thereof according to an embodiment of the present invention. Further, FIG. 2 is a schematic view showing a cellular phone as an example of an apparatus having such configuration. Mobile devices including a cellular phone and a mobile communication device are desired to consume as low power as possible while operating at high speed. Accordingly by mounting the memory controller of this embodiment, a mobile device with low power consumption and high speed memory accesses can be accomplished.

Note that as shown in FIG. 2, a general cellular phone 300 is covered by a housing 307, buttons for dial 301, operation buttons 302, a liquid crystal display 303, a microphone 304, a speaker 305, and an antenna 306. An apparatus shown in FIG. 1 is mounted to the cellular phone so as to save or read an image shot by a camera not shown and an e-mail received by a communication mean.

As shown in FIG. 1, a DMA 11 and a CPU 12 are connected to a memory controller 20 via a bus 13. A memory controller 20 is connected to a memory 14. The memory controller 20 includes a command queue 21 for holding access requests from the DMA 11 and CPU 12, and a command issuer 22 for issuing a command to a memory 14 according to the command that is held to the queue 21. Here, the command issuer 22 includes an address comparator 23 for comparing a writing or reading address of the memory 14. The address comparator 23 determines whether 2 or more of access requests that are stored to the queue are access requests for a same page of the memory 14.

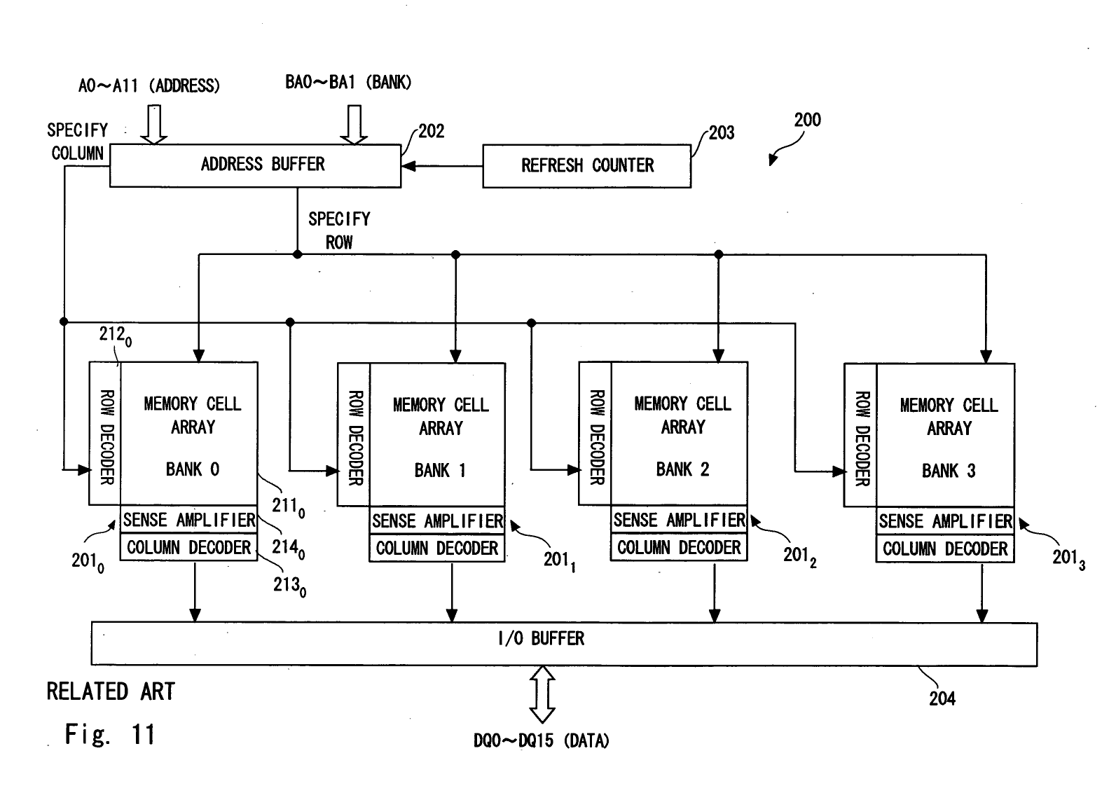

The memory 14 is for example the SDRAM shown in FIG. 11. A page of the memory 14 refers to an address indicated by a particular row of a particular bank. Accesses for a same page refer to consecutive access requests indicating a same bank and a same row address. For example in the example of FIG. 11, a particular column and a particular row is selected by an address A0 to A11, for example, that are input to the address buffer 202. When one page is selected by a particular bank and a particular row, the selected page is activated and data can be read from an arbitrary column address in the activated page.

Furthermore the memory controller 20 of this embodiment does not pre-charge after a read/write operation only for an access request for the same page, but performs a consecutive read/write operation to reduce the latency. Specifically, one page is activated by specifying a particular bank and a particular row according to an access request to access a specified column access, if a next access request is for a same page as the corresponding page (same bank and same row), the corresponding page is maintained to be activated to process the next access request. This enables to immediately access to a specified column address without activating a page again. On the other hand if the access requests are not for the same page, the power consumption is reduced by pre-charging after the read/write operation.

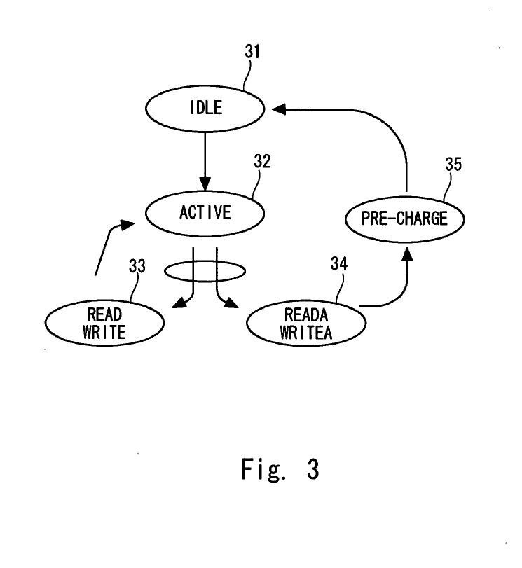

FIG. 3 is a state transition diagram of the memory 14. The memory 14 transits from an IDLE state 31 to an ACTIVE state 32 in response to an input of an active command ACT. If access requests are for a same page, a read/write command READ/WRITE is issued, the memory 14 becomes a READ/WRITE state 33, executes a read/write operation, and returns to the ACTIVE state 32.

If the access requests are not for the same page, a read/write command with auto pre-charge READA/WRITEA is issued, the memory 14 becomes a READ/WRITE state (READA/WRITEA) 34, executes a read/write operation, automatically transits to a PRE-CHARGE state 35, and returns to the IDLE state 31. Specifically, the memory 14 of this embodiment does not become the PRE-CHARGE state 35 as long as the memory controller 20 accesses for the same page, but the memory 14 is controlled to transit to the ACTIVE state 32 after the read/write operation.

An operation is described hereinafter in detail. In the explanation below, a read operation is described as an example, however it is same for a write operation. The DMA 11 and CPU 12 that are connected to the bus 13 access to the memory 14 via the memory controller 20. The command queue 21 of the memory controller 20 holds 2 or more access requests (commands) to a memory access. The command issuer 22 issues various commands to transit the state of the memory including a command ACT for transiting to the ACTIVE state, a command PRE for pre-charging, a command READ for executing a read operation, and a read command READA with auto pre-charge for automatically pre-charging after executing a read operation.

Here, whether a pre-charge is performed after a read operation depends on a comparison result of the address comparator 23. Specifically, the address comparator 23 evaluates whether addresses that consecutive two access requests read therefrom are in the same page. If the address comparator 23 determines that they are in the same page, a pre-charge is not performed after the read operation and continues to read.

Further, there are two methods to pre-charge after a read operation. The methods are; A1 in which a pre-charge command is issued after issuing a READ command, and A2 in which a pre-charge is automatically performed after a read operation by a read command with auto pre-charge READA.

Furthermore, there are two kinds of timings for the address comparator 23 to compare addresses. The timings are; a timing B1 in which two access requests are queued in the command queue 21, and a timing B2 in which an access request is stored to the command queue 21 while issuing a next command after processing one access request. By comparing addresses at the timing B1, in which an access request is stored to the queue 21 to issue a command, it is possible to reduce the latency if the access requests are for the same page. Further, if comparing addresses at the timing B2 in which an access request is stored to the command queue 21 while issuing a next command after processing one access request, the address comparator compares whether the accesses are for a same page as a read command currently being executed. In this case, the comparison time can be longer because an address comparison can be performed for an access request that is queued after issuing one READ command to issuing a next command.

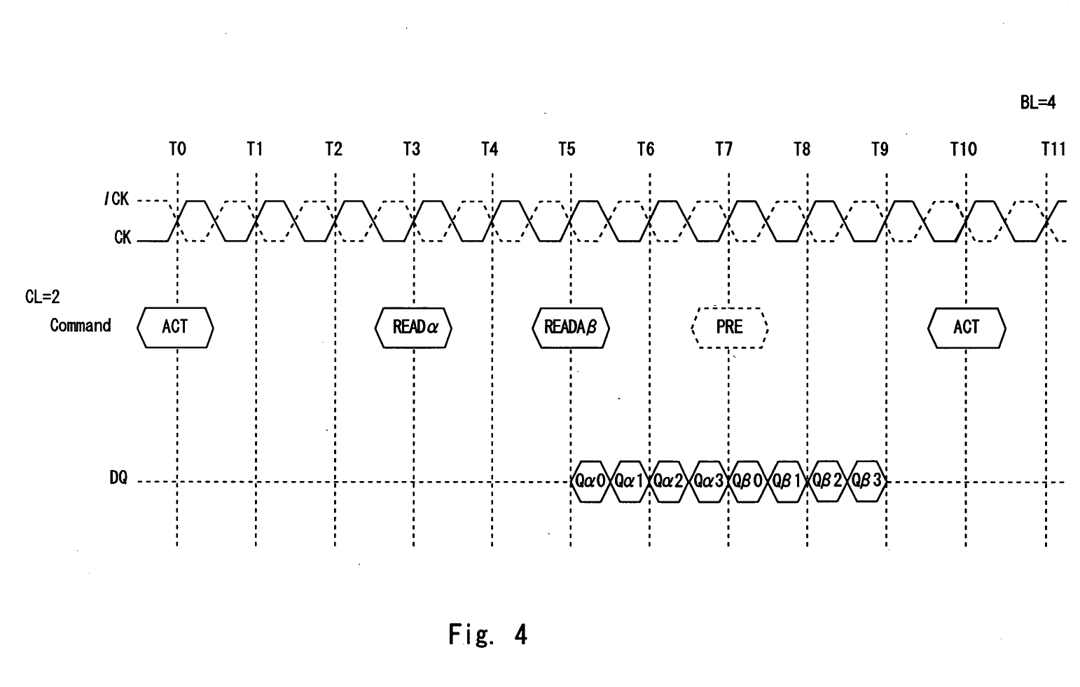

An operation of the memory controller of this embodiment for each case is described hereinafter in detail. FIGS. 4 to 6 are timing charts showing operations of the memory controller. At this time, for B1, specifically two memory access requests are queued to the queue 21 and until a first read command is issued, another read command is evaluated to be an access for the same page, the comparison of the address comparator 23 is completed by the timing T3 of FIG. 3. On the other hand for B2, specifically after issuing one read command, the comparison by the address comparator 23 is completed by the timing T5, in which a next command (PRE or READ) is issued. Firstly, a case in which addresses are compared at a timing T3 is described hereinafter in detail.

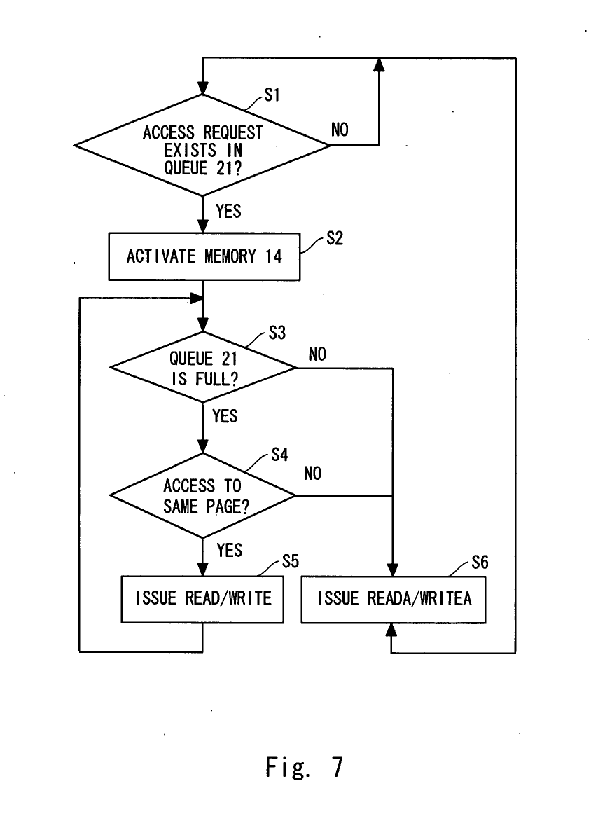

FIG. 7 is a flowchart showing an operation of the memory controller 20 in comparing addresses at the timing T3. As shown in FIG. 7, if an access request to the memory 14 is stored to the queue 21 (step S1), the command issuer 22 issues the active command ACT as indicated by a timing T0 of FIG. 4. Specifically, a corresponding page is activated by specifying a bank and a row of an address specified by an access request to transit from the IDLE state to ACTIVE state where data can be read and written (step S2).

Then the queue 21 is evaluated to be full or not (step S3). The queue 21 of this embodiment is able to queue up to two access requests from the DRAM 11 or CPU 12. Accordingly, if the queue is full, specifically there are two access requests, the address comparator 23 compares whether the access requests are for a same page using the addresses (step S4). In this example, a read command issued first is referred to as READα or READAα, and a read command issued next is referred to as a READβ or a READAβ.

If the access requests are for the same page (step S4:YES), an auto pre-charge is not used to execute a consecutive read operation and READα is issued at a timing T3 as shown in FIG. 4. At this time, specified column data in an activated page can be read by specifying a column address. By issuing READα, after a predetermined time (CL=2) has passed, data Qα0 to Qα3 is read. The evaluation in the step S4 is performed by the timing T3.

Note that the SDRAM has a burst transmission feature. A burst transmission is to consecutively transfer data of following addresses only by specifying one address. For example as for a program, basically to retrieve consecutive instructions to execute, addressing by a microprocessor side is not required, thus the data can be retrieved at high speed by a burst transmission. In this example, it is explained that one read operation is to read 4 bit data, however the number of bits for readout data is not limited to this.

Turning back to FIG. 7, after issuing READα, it is evaluated whether a next access request exists in the queue 21 or not, specifically if the queue 21 is evaluated to be full or not (step S3), the evaluation of the step S4 is performed if there is an access request. On the other hand, if a next access request does not exist (step S3:NO), or if READ/READβ and the next access request are not accessing to a same page (step S4:NO), the flow proceeds to step S6. In such case, a read command with auto pre-charge READAβ is issued (step S6, timing T5 of FIG. 4). The evaluation of the step S4 is performed by the timing T5.

As shown in FIG. 3, the memory 14 returns to the ACTIVE state 32 after transiting to the READ state 33 and executing READα, the memory 14 returns to the ACTIVE state 32. Thus the memory 14 is able to execute a read operation command by a next READAβ. After issuing READAβ at the timing T5 and after a predetermined time has passed (CL=2), data Qβ0 to Qβ3 is read out. The read command with auto pre-charge READAβ is that a pre-charge is automatically performed after the read operation, the activated row is deactivated to return to the IDLE state.

If there is no next access request, the memory stays and waits in the IDLE state 31. Further, if there is a next access request, after a predetermined time (tRP) has passed, the memory issues an active command ACT to be in the ACTIVE state to execute a read operation etc.

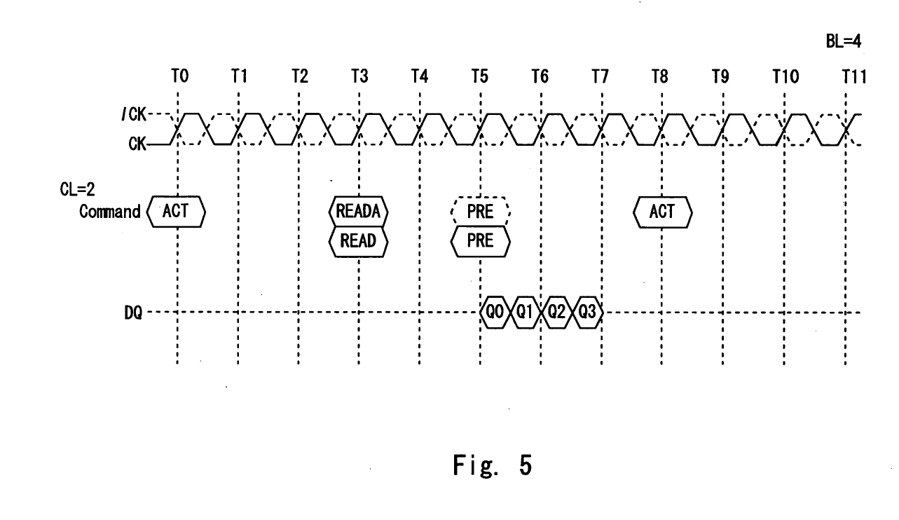

In this example, requests are evaluated if they access to a same page, and if the accesses are for the same page, READ is issued. On the other hand if the accesses are not for the same page, it is explained that a read command with auto pre-charge READA is issued as shown in FIG. 5. However in such case as well, READ can be issued to issue PRE. An auto pre-charge is that after issuing a read command with auto pre-charge READA, a pre-charge is automatically pre-charged after (burst length/2) clocks. Needless to say that the pre-charge PRE can be issued at this timing.

By the way, if the accesses are not for the same page but for different pages, there can be two following cases.

1) Accesses for a same bank but different row addresses

2) Accesses for different banks

If the next access after READAβ is for a same bank and a different row address, an active command ACT for activating a different page for the next access request is issued at a timing T10 of FIG. 4 in which the READAβ is pre-charged.

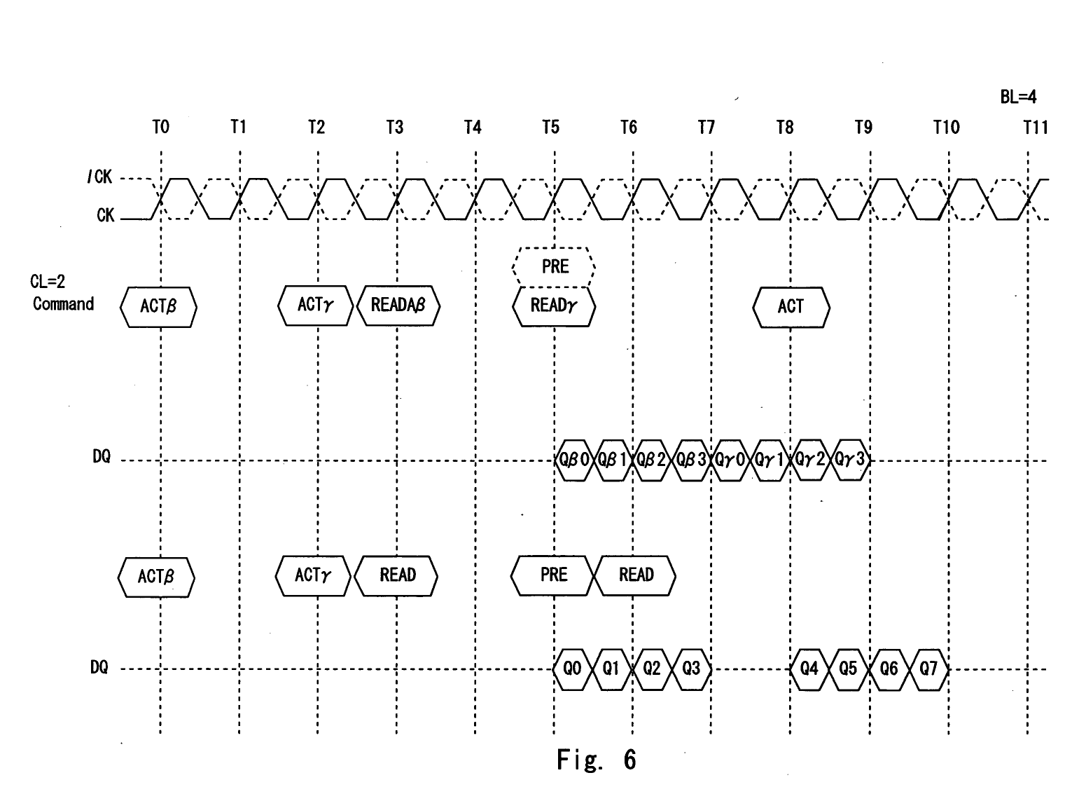

On the other hand if the next access after READAβ is for a different bank, an advantageous effect described hereinafter can be effective by issuing the read command with auto pre-charge READA. FIG. 6 is a timing chart explaining a difference in operations of READ and READA in accessing different banks.

If the accesses are for different banks, an active command ACT can be issued previously to a next read command following READAβ. Here, the active command issued before the READAβ is referred to as an ACTβ, a read command for a different bank following the READAβ is referred to as a READγ, and an active command issued before the READγ is referred to as an ACTγ.

As shown in FIG. 6, the ACTβ is issued at a timing T0 for the READβ. If the next access request is for a different bank, the active command ACTγ can be issued. Accordingly the ACTγ is issued at a timing T2. Then the READAβ is issued at a timing T3, in which a predetermined time of the ACTβ (tRCD) has passed, and data QβO to Qβ3 is read from a timing T5.

On the other hand, a next command can be issued at the timing T5, in which the predetermined time (tRCD) has passed after the ACTγ is issued. Here, as the read command READβ is with auto pre-charge, a pre-charge command PRE does not needs to be issued and the READγ can be issued. This enables to read data from a timing T7 if the requests are for different banks, thus data can be consecutively read out.

On the other hand a case of using the READβ is shown in FIG. 6. Specifically, it is possible to issue the READγ at the timing T5, in which the predetermined time of the ACTγ has passed. However as the pre-charge command PRE is issued at the timing T5 because the pre-charge command PRE must be issued. Therefore, the timing to issue the READγ is a timing T6, which is one cycle delayed as compared to FIG. 6.

As described in the foregoing, if evaluated that the accesses are not for the same address, a readout timing can be faster by issuing the read command with auto pre-charge READA instead of the read command READ, if a next access request is for a different bank.

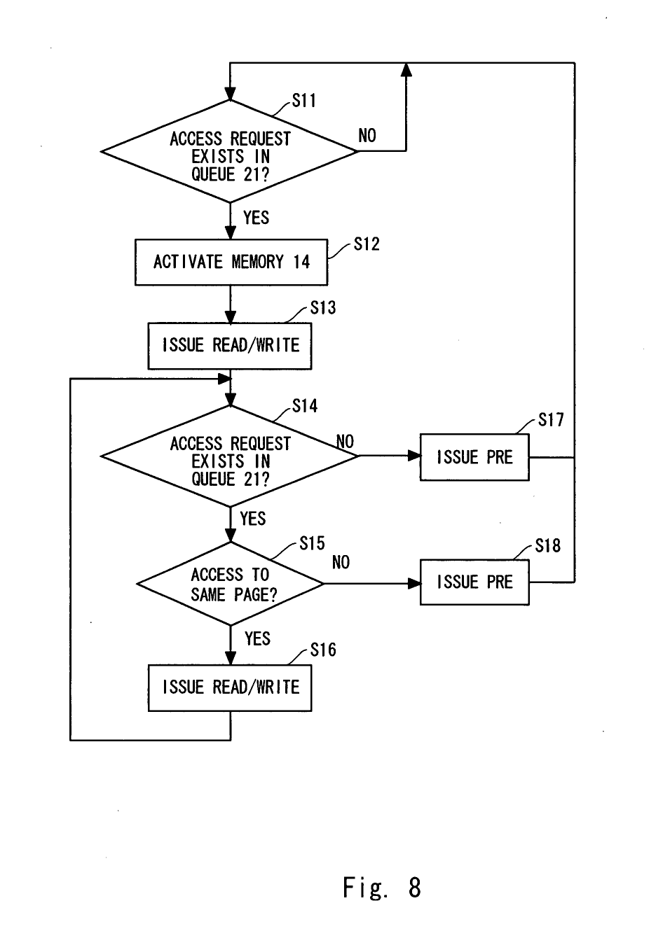

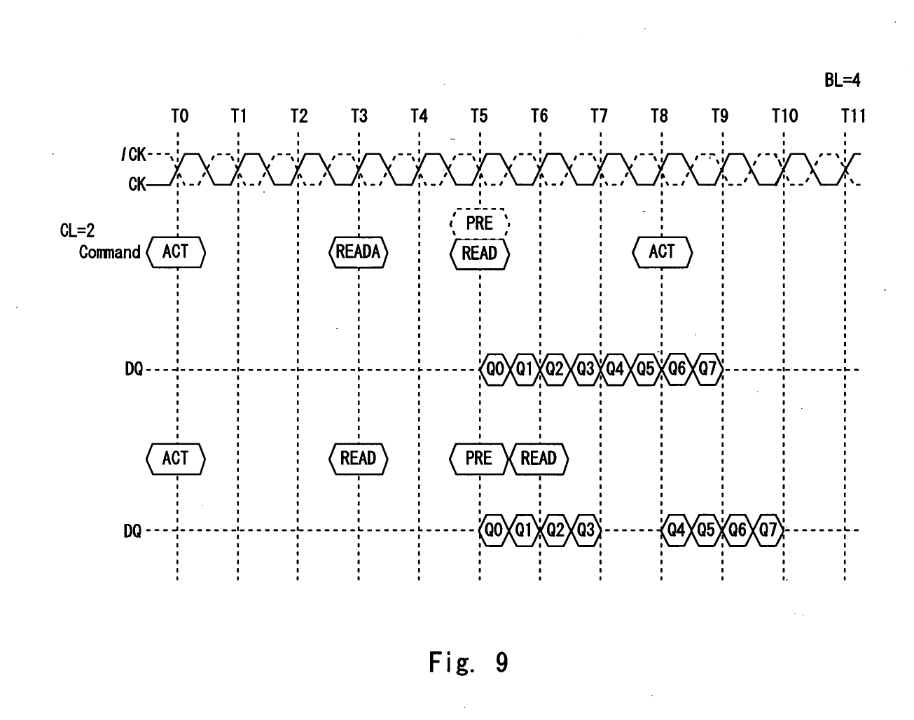

A case of comparing addresses at the timing T5 is described hereinafter in detail. FIG. 8 is a flowchart showing an operation of the memory controller 20 when comparing addresses at the timing 5. Further, FIG. 9 is a timing chart thereof.

After an access request is stored to the queue 21 (step S11:YES), a bank and a row of an address specified by the access request is specified to activate a corresponding page so as to transit from the IDLE state to the ACTIVE state, in which data can be read and written (step S12, ACT at a timing T0). Then the read command READ is issued (step S13, READ at the timing T3).

After the read command READ is issued, if a next access request is for a same page, a read command READ is consecutively issued. If the next access request is for a different page, the pre-charge command PRE is issued. Accordingly the address comparator 34 needs to evaluate whether the issued READ and the next access request are for a same page by the timing T5. Firstly if there is no access request in the queue 21 (step S14:NO), the pre-charge command PRE is issued (step S17). If there is an access request in the queue 21 (step S14:YES), the access request is evaluated if it accesses to a same page (step S15). If the access request is for a different page, the pre-charge command PRE is issued (step S18). On the other hand, if the access request is for the same page, the read command READ is issued at the timing T5. By the consecutive read commands at the timings T3 and T5, data Q0 to Q7 can be read out.

After issuing the READ, processes from the step S14 are repeated. Further, a pre-charge command PRE is issued at the steps S17 and S18. This deactivates an activation of a row in the memory 14, and the memory 14 returns to the IDLE state.

In this embodiment, among the access requests stored to the queue, two consecutive access requests are evaluated whether they access to a same page. If they access for the same page, an unnecessary latency is removed by performing a consecutive read/write operations while maintaining to be the ACTIVE state. Further, by performing the evaluation at when the two access requests are queued, it is possible to reduce the latency at an earlier timing. On the other hand by performing the evaluation at a timing when a next access request is queued while processing one access request, the evaluation time can be longer. Furthermore, if the accesses are for different pages, the latency in accessing different banks can be reduced by using a read/write command with auto pre-charge READA/WRITEA.

It is apparent that the present invention is not limited to the above embodiment and it may be modified and changed without departing from the scope and spirit of the invention.

What is claimed is:

1. A memory control apparatus comprising:
a queue to store 2 or more access requests to a memory; and
a command issuer to include an evaluator to evaluate whether the 2 or more access requests stored to the queue are access requests to a same page of the memory and to issue a command to the memory according to the evaluation result by the evaluator.

2. The memory control apparatus according to claim 1, wherein the command issuer consecutively issues read/write commands if consecutive access requests are for a same page of the memory, whereas if consecutive access requests are for different pages, the command issuer issues a command to pre-charge.

3. The memory control apparatus according to claim 2, wherein the command issuer issues a read/write command with an auto pre-charge after issuing a command if access requests are for different pages.

4. The memory control apparatus according to claim 2, wherein the command issuer issues a pre-charge command if access requests are for different pages.

5. The memory control apparatus according to claim 1, wherein the evaluator evaluates whether two of the access requests stored to the queue are for a same page, and
the command issuer issues a read/write command with an auto pre-charge to automatically pre-charge after the command is issued if the two access requests are for different pages.

6. The memory control apparatus according to claim 1, wherein the evaluator evaluates whether an address indicated by the issued read/write command and an address indicated by an access request are for a same page, if the access request is stored to the queue from after the read/write command is issued to the pre-charge command is issued, and
the command issuer issues a read/write command consecutively to the previously issued read/write command if the addresses are for a same page.

7. The memory control apparatus according to claim 1, wherein the queue stores up to two access requests.

8. A method for memory control comprising:
evaluating whether 2 or more of the access requests stored to a queue are for a same page of a memory, the queue storing 2 or more of access requests to the memory; and
issuing the command according to the evaluation result.

9. The method according to claim 8, wherein in the issuance of the command, read/write commands are consecutively issued if consecutive access requests are for a same page of the memory, whereas if consecutive access requests are for different pages, a command to pre-charge-the memory is issued.

10. The method according to claim 9, further comprising issuing a read/write command with an auto pre-charge if the access requests are for different pages, the read/write command with an auto pre-charge automatically pre-charging after being issued.

11. The method according to claim 9, further comprising issuing a pre-charged command if the access requests are for different pages.

12. The method according to claim 9, further comprising:
evaluating two of the access requests to be for a same page if two of the access requests are stored to the queue; and
issuing a read/write command with an auto pre-charge to automatically pre-charge after issuing a command, if the two access requests are for different pages.

13. The method according to claim 9, further comprising:
evaluating whether an address indicated by the issued read/write command and an address indicated by an access request are for a same page, if the access request is stored to the queue while the memory is in an active state;
issuing a read/write command consecutively to the previously issued read/write command if the addresses are for a same page; and
issuing a pre-charge command if the addresses are for different pages.

14. A mobile device comprising:
a memory;
a memory controller to control the memory; and
a controller to access the memory via the memory control apparatus,
wherein the memory controller comprises:
a queue to store 2 or more access requests to the memory; and
a command issuer to include an evaluator to evaluate whether the 2 or more access requests stored to the queue are access requests to a same page of the memory and to issue a command to the memory according to the evaluation result by the evaluator.
